(19) United States
(12) Patent Application Publication
(10) Pub. No.: US 2001/0029175 A1
(43) Pub. Date: Oct. 11, 2001

(54) Generating and logging reminders whilst mobile

(76) Inventors: Abigail Jane Sellen, Newbury (GB); Colin I'Anson, Frenchay (GB)

Correspondence Address: Allan M. Lowe, LOWE HAUPTMAN GILMAN & BERNER, LLP, Suite 310, 1700 Diagonal Road, Alexandria, VA, 22314, US

(21) Appl. No.: 09/796,752

(22) Filed: Mar. 2, 2001

(30) Foreign Application Priority Data
Mar. 3, 2000 (GB) 0005026.00

(51) Int. Cl. H04M 11/10

(52) U.S. Cl. 455/412; 455/414; 455/466; 455/567

(57) ABSTRACT

A mobile user wishing to quickly generate a reminder note for him/herself, does so by activating a special “reminder” function of the user's mobile phone. This results in a voice path being set up through the mobile phone infrastructure to a service system to which the user then dictates the desired reminder note. The service system puts the reminder into an e-mail and sends it through an e-mail system to a special “reminder” e-mail box of the user from where the user can subsequently collect it. In an alternative embodiment, the reminder is temporarily stored in the mobile phone before uploading, possibly over a data bearer service offered by the infrastructure. In another alternative embodiment, the reminder is converted into e-mail in the mobile phone and then sent as such to the user's reminder e-mail box without being further handled by a service system.

### FIELD OF THE INVENTION

The present invention relates to the generation of verbal reminders whilst mobile and, in particular, but not exclusively, to a service system for handling such reminders.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a full traffic circuit is used for carrying data and the MSC 32 routes the circuit to an InterWorking Function IWF 34 the precise nature of which depends on what is connected to the other side of the IWF. Thus, IWF could be configured to provide direct access to the public Internet 39 (that is, provide functionality similar to an IAP—Internet Access Provider LAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

People often think of things they should do (or should have done) and, in order not to forget to take some related action, make themselves a quick reminder (for example, a simple written note). However, persons driving a vehicle or doing something else that requires their continuous attention, cannot make the normal types of reminders. For such people, verbal reminders, if they can be generated, would be the most convenient and least likely to cause sustained distraction from the task in hand.

As more and more people come to have personal mobile telephones, it would be useful to find some way of being able to use these telephones also as a means for recording verbal reminders. The use of cell phones for recording speech has been previously, for example in the following three U.S. patents:

U.S. Pat. No. 5,867,793 describes a cell phone with built-in digital message recorder which can be used by user to record message for subsequent transmission, or for recording calls for subsequent local playback.

U.S. Pat. No. 5,995,824 discloses an arrangement for effecting call recordal and storage either locally in a cell phone or in a mobile network voice-mail box. The arrangement is primarily intended as a safety aid for drivers, enabling them to start recording a call at any time. In one embodiment the recording is done in a voice-mailbox connected to the MSC/VLR (this being achieved by the set up of a three-way call connection). Retrieval of the recorded speech is done in standard manner for accessing voicemail.

U.S. Pat. No. 5,790,957 teaches a system for effecting speech recall in cell phone in which a user-dictated message or an incoming call can be stored in local memory and subsequently played back locally or sent to a distant phone.

To the extent that any of the above-disclosed arrangements is capable of being used for recording personal reminders, they all suffer from the drawback of requiring the user to use the cell phone to retrieve the reminder.

It is an object of the present invention to provide a system and method for recording verbal reminders which then makes them available back to the user in a convenient way.

### SUMMARY OF THE INVENTION

According to one aspect of the present invention, there is provided a method of logging verbal reminders from a mobile user using a mobile device that can communicate with a mobile radio infrastructure, the method involving carrying out the following steps:

(a) activating the mobile device for receiving a reminder and vocally inputting the reminder into the device;

(b) converting the reminder into electronic format in the device; and

(c) transmitting the reminder in electronic format over the radio infrastructure to a message store on a data network, and storing the reminder in the message store for subsequent access, the message store being associated with said user.

The user can thus record a verbal reminder and have it sent to their e-mail box for reading along with their other e-mail (and preferably with a subject heading of “Reminder”). Since checking e-mail is regular daily routine for most business users, the reminder is unlikely to get forgotten as could be the case with the prior arrangements for recording reminder messages through a cell phone.

According to another aspect of the present invention, there is further provided a service system for handling user-generated reminders, the system comprising:

input means for receiving a verbal reminder through a telephone network together with a user ID indicative of the originator of the reminder;

means for converting the user ID into a corresponding address on a data network, this address being associated with the originator of the reminder,

output means for incorporating the reminder into a message having as its destination address said address associated with the originator of the reminder,

means for sending the reminder-bearing message out over said data network.

### BRIEF DESCRIPTION OF THE DRAWINGS

Methods of logging verbal reminders whilst mobile and a service-system for transferring verbal reminders, both embodying the present invention, will now be described, byway of non-limiting example, with reference to the accompanying diagrammatic drawings, in which:

FIG. 1 is a diagram of a known communications infrastructure usable for transferring voice and data to/from a mobile entity;

FIG. 2 is a diagram illustrating a first method implementing the present invention which uses an intermediate service system;

FIG. 3 is a diagram illustrating a second method implementing the present invention, this method also using an intermediate service system; and

FIG. 4 is a diagram illustrating a third method implementing the present invention.

### BEST MODE OF CARRYING OUT THE INVENTION

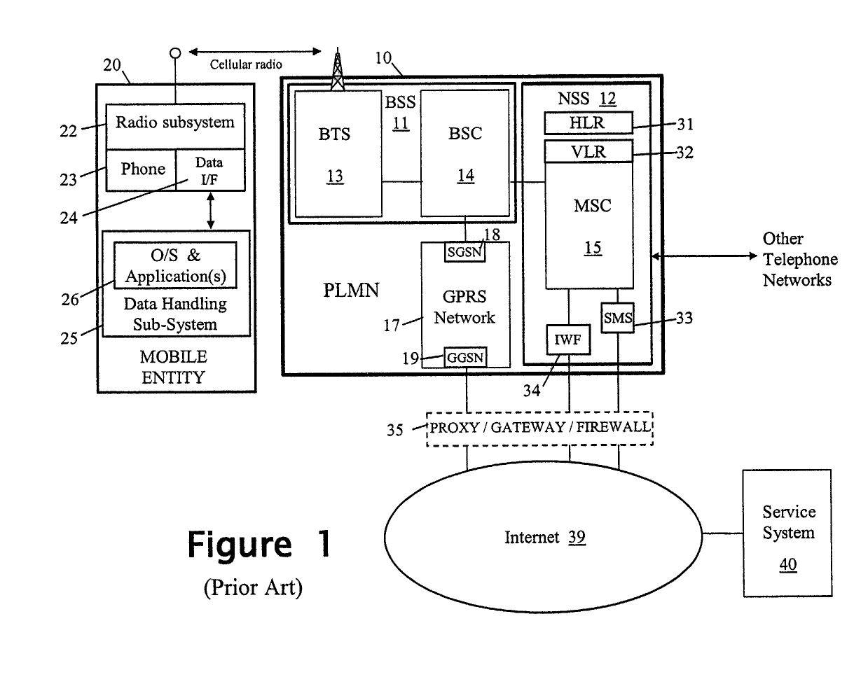

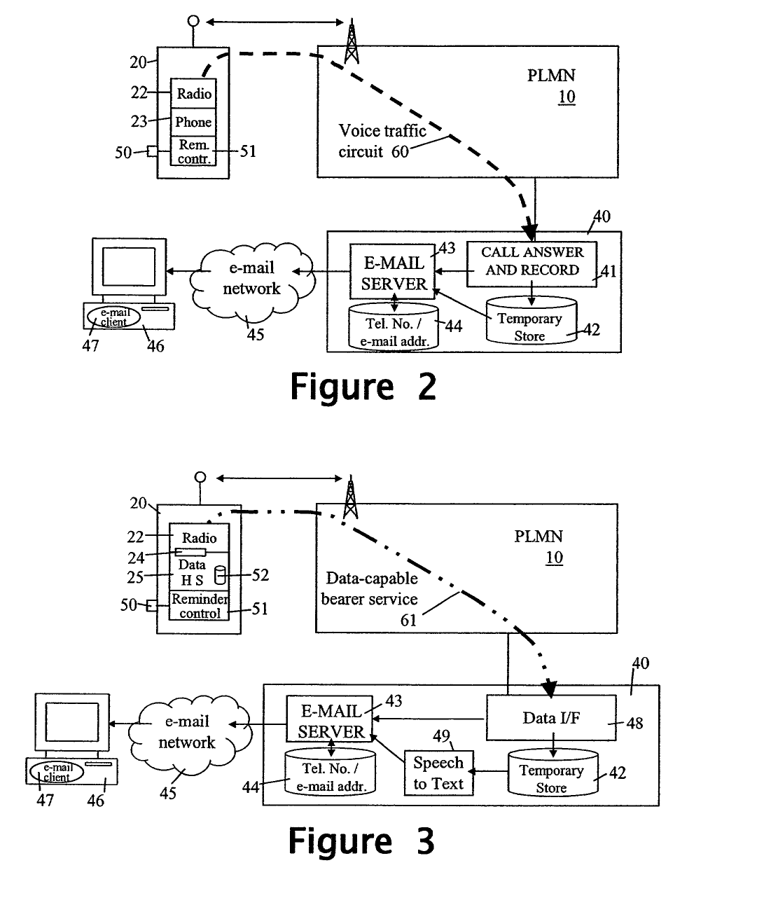

Reminder-logging methods and service systems embodying the invention will now be described with reference to FIG. 2 to 4. It is to be understood that the present invention is not limited to the specifics of the mobile entity and communication infrastructure shown in FIGS. 2 to 4 and the generalisations discussed above in relation to FIG. 1 regarding these elements apply equally to the present invention unless otherwise indicated.

Considering first the embodiment of FIG. 2, a mobile entity 20 in the general form of a cell phone is provided with a reminder control circuit 51 which, when triggered by user operation of an input element (e.g. a button) 50, is effective to cause a voice traffic circuit 60 to be set up through a PLMN 10 (and possibly a connected PSTN) to a service system 40. The user of mobile entity can now dictate a message which is passed as a voice call to the service system.

The service system 40 comprises a call answer subsystem 41 with associated temporary store 42, and an e-mail server 43 with a database 44 for translating telephone numbers to e-mail addresses. The call answering subsystem 41 is operative to capture details (for example, calling party number) of an incoming call over voice traffic circuit 60 and to record the call in digitised form in store 42. Upon the call being terminated the call answer subsystem 41 passes the call details to the e-mail server which forms an e-mail including the recorded voice call retrieved from store 42. The destination address of the e-mail is obtained by doing a look-up in database 44 using the calling party number as the search key. The e-mail is then sent out over e-mail network 45 and is in due course downloaded by an e-mail client 47, here shown as running in a PC 46.

A user wishing to use the reminder service first registers with the service and specifies both the number of the user's associated cell phone 20 and the e-mail address to which the user wishes their dictated reminders to be sent. These details are stored in the database 44. Thereafter, the user can at any time record a reminder simply by operating trigger input 50 to set up voice circuit to the service system and then dictating the reminder into the cell phone. The service system 40 records the message and forwards it in an e-mail message to the e-mail address specified by the user. The user can then later retrieve his/her reminders from their e-mail box via e-mail client 47.

The trigger input 50 can take various forms. For example, the input can be a hard or soft button provided directly on the cellular phone, on a phone accessory or in a very accessible place for the driver of a car. In the latter case, a button can be provided on the steering wheel and connected back to the cellular phone; various methods can be used for connecting the steering wheel button to the phone, for example, an infrared link could be used or the same electrical connection that would be used to connect to a portable PC. The input 50 is not limited to being a button and could, for example, be in the form of a voice recognition circuit.

As regards the reminder control 51 that is triggered by operation of input 50, this can configured simply to provide speed dial functionality for dialing the service system. The appropriate dialing sequences can be stored in the main number memory of the phone or in a memory associated with the control 51 itself.

When the service system answers the call, it can be arranged to play a prompt message to the user. As already noted, the identity of the cell phone is made known to the service system—this can be done by calling party ID as mentioned above, by an in-band data transfer (for example by using DTMF tones), or by an enquiry made by the service system to PLMN 10 via a proprietary or open interface.

With respect to the e-mail message generated by e-mail server 43, this message can contain in addition to the digitised reminder, further details of the call such as time received, length, etc., as text. The subject field of the message can conveniently be used to indicate that this is a reminder. The e-mail source address is also clearly coded to identify that it originated with the reminder service system.

The e-mail destination address may be either the main e-mail address for the user or a special “reminder” address for the user. In the former case, when the e-mail arrives at the user's e-mail client (or-e-mail server that services multiple clients), the source and subject fields can be used to identify that this is a reminder. The message is then placed in the inbox or a specific mail folder for reminders. The reminders can be further manipulated by the e-mail client to make them more obvious, for example placing them onto a task list in a calendar application.

The user can then listen to these reminder messages from their e-mail in-box or can reroute them to a multimedia to-do list. This can remain in their e-mail system or may be implemented via a personal organiser appliance.

FIG. 3 shows a second embodiment of the invention in which the mobile entity includes a data-handling subsystem 25 with local data store 52. In this embodiment, when the user activates input 50 to record a reminder, the reminder control 51 (in the form of an application run by the subsystem 25) causes the dictated reminder to be digitized and temporarily stored in local store 52. Subsequently (for example, during low tariff periods), the reminder control initiates the set up of a data bearer channel 61 through the PLMN 10 to a data interface 48 of the reminder service system 40. A user identifier and other reminder details are then passed over this data channel, together with the digitized reminder, to the service system 40 where the reminder is temporarily held in store 42.

Service system 40 could then function as already described above in relation to the FIG. 2 to generate an e-mail and send it out over e-mail network 45 to be retrieved in due course by e-mail client 47. However, in the FIG. 3 embodiment a further operation is performed in service system by which the digitized reminder is converted to text before being included in the e-mail message, this conversion being effected by block 49. Converting the reminder to text form substantially reduces the amount of data to be included in the e-mail. It will be appreciated that a speech-to-text conversion block could also have been provided in the FIG. 2 service system. Furthermore, rather than including the speech-to-text conversion block in the service system 40, it would be possible to include the conversion block in the mobile entity 20 itself provided that adequate processing power was available in entity 20.

With regard to the FIG. 3 service system 40, whilst this is shown as connected directly to the PLMN 10, it will be appreciated that the service system could be connected to the PLMN via the public Internet (as in FIG. 1), to a GPRS network of PLMN 10, or to another fixed data network interfacing directly or indirectly with the network 17 or network 39.

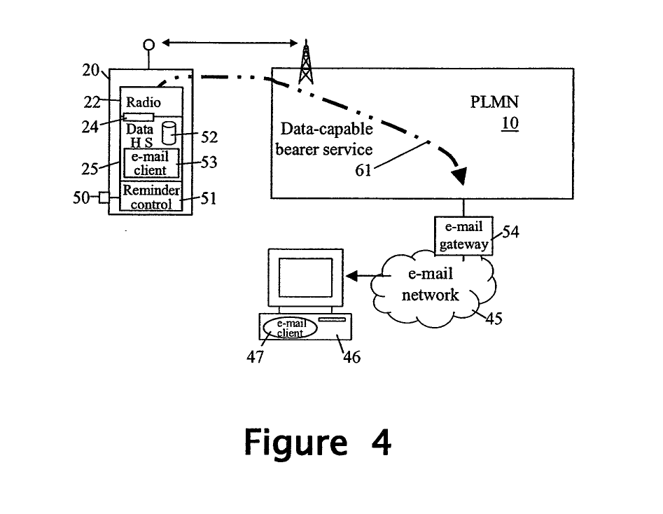

A further embodiment is shown in FIG. 4. In this embodiment, the dictated reminder is temporarily stored in mobile entity as for the FIG. 3 embodiment. However, the reminder (with or without conversion to text format) is then formed directly into an e-mail in the mobile entity itself and sent via a data bearer channel 61 through the PLMN 10 to an e-mail gateway 54 on e-mail network 45. The e-mail is addressed to the user's e-mailbox, the e-mail address of the latter being stored in the data handling subsystem 25. The FIG. 4 embodiment avoids the need for a special service system for forwarding on the reminder as an e-mail.

The above-described embodiments are based on the use of GSM and e-mail. As already indicated, the present invention is not limited to such implementation specifics. For example, any store and forward data transfer method can be used in place of e-mail (such as Lotus Notes), and any appropriate mobile communications network can be used (such as IS95).

1. A method of logging verbal reminders from a mobile user using a mobile device that can communicate with a mobile radio infrastructure, the method involving carrying out the following steps:
(a) activating the mobile device for receiving a reminder and vocally inputting the reminder into the device;
(b) converting the reminder into electronic format in the device; and
(c) transmitting the reminder in electronic format over the radio infrastructure to a message store on a data network, and storing the reminder in the message store for subsequent access, the message store being associated with said user.

2. A method according to claim 1, wherein activating the mobile device for receiving a reminder in step (a) initiates the set up of a connection through the mobile radio infrastructure to a service system on the data network, the reminder being transmitted over the connection to the service system in step (c) substantially as the reminder is vocally input; step (c) further involving:
incorporating the reminder into a message at the service system,
addressing the message to the message store associated with the user, and
sending the message out over the data network from the service system to the message store.

3. A method according to claim 1, wherein step (c) is deferred relative to steps (a) and (b), the reminder being temporarily stored in the mobile device prior to step (c) being effected, step (c) involving:
setting up a connection through the mobile radio infrastructure to a service system on the data network,
transmitting the reminder over the connection to the service system,
incorporating the reminder into a message at the service system,
addressing the message to the message store associated with the user, and
sending the message out over the data network from the service system to the message store.

4. A method according to claim 3, wherein step (c) is effected at a time when the tariff for the data-capable service used is relatively low.

5. A method according to claim 2, wherein said connection comprises a voice circuit through the mobile radio infrastructure.

6. A method according to claim 2, wherein said connection comprises a data connection over a data-capable service through the mobile infrastructure.

7. A method according to claim 2, wherein step (c) further involves effecting a speech to text conversion on the reminder at the service system, the reminder being incorporated in text form in said message sent out over the data network.

8. A method according to claim 2, wherein step (b) further involving effecting a speech to text conversion on the reminder, the reminder being transmitted to the service system in step (c) in text form.

9. A method according to claim 2, wherein said message is an e-mail message and is addressed to an e-mail box dedicated to reminders for the user.

10. A method according to claim 2, wherein the message is formed with a subject field indicating that it is a reminder message.

11. A method according to claim 2, wherein the set up of said connection involves the supply of a calling ID to the service system in respect of the mobile device, the service system using this ID to look up a destination address on the data network for the reminder and sending the reminder-bearing message to this address.

12. A method according to claim 1, wherein in step (b) the reminder is converted into an electronic message addressed to the message store associated with the user, step (c) involving sending the message over a data-capable bearer of the mobile radio infrastructure to the data network and through the latter to the message store.

13. A method according to claim 12, wherein step (c) is deferred relative to steps (a) and (b), the reminder being temporarily stored in the mobile device prior to step (c) being effected.

14. A method according to claim 12, wherein step (b) involves effecting a speech to text conversion on the reminder for inclusion in said electronic message.

15. A method according to claim 14, wherein step (c) is deferred relative to steps (a) and (b), the reminder being temporarily stored in the mobile device prior to step (c) being effected.

16. A method according to claim 15, wherein step (c) is effected at a time when the tariff for the data-capable service used is relatively low.

17. A method according to claim 12, wherein said message is an e-mail message and is addressed to an e-mail box dedicated to reminders for the user

18. A method according to claim 12, wherein the message is formed with a subject field indicating that it is a reminder message

19. A service system for handling user-generated reminders, the system comprising:
input means for receiving a verbal reminder through a telephone network together with a user ID indicative of the originator of the reminder;
means for converting the user ID into a corresponding address on a data network, this address being associated with the originator of the reminder,
output means for incorporating the reminder into a message having as its destination address said address associated with the originator of the reminder,
means for sending the reminder-bearing message out over said data network.

20. A system according to claim 19, wherein said user ID is a telephone number.

21. A system according to claim 18, wherein said input means comprises a voice circuit interface.

22. A system according to claim 19, wherein said input means comprises a data interface for receiving said reminder as data over a data-capable service of a mobile telephone infrastructure.

23. A system according to claim 19, including means for effecting a speech to text conversion on the reminder, the reminder being incorporated in text form in said message.

24. A system according to claim 19, including means for providing said message with a subject field indicating that it is a reminder message.
